(19) United States
(12) Patent Application Publication
(10) Pub. No.: US 2026/0032576 A1
(43) Pub. Date: Jan. 29, 2026

(54) USER EQUIPMENT SEARCH AND SELECTION FOR AIRBORNE WIRELESS SERVICE

(71) Applicant: T-MOBILE INNOVATIONS LLC, Overland Park, KS (US)

(72) Inventors: Bhagwan Singh KHANKA, Las Vegas, NV (US); Brandon James BRAUNLICH, Henderson, NV (US)

(21) Appl. No.: 18/788,073

(22) Filed: Jul. 29, 2024

(51) Int. Cl. H04W 48/20; H04W 28/02; H04W 48/16; H04W 72/0453; H04W 72/56

(52) U.S. Cl. CPC H04W 48/20; H04W 28/0226; H04W 48/16; H04W 72/0453; H04W 72/56

(57) ABSTRACT

Embodiments of the present disclosure are directed to systems and methods for delivering telecommunications coverage to airborne user equipment (UE). More particularly, in aspects set forth herein, systems and methods utilize an “airborne mode” that can be on the UE. The UE can automatically turn on the airborne mode when it detects that the UE is airborne. For example, the UE may detect a particular altitude, speed, or pressure that is associated with being airborne. The airborne mode could be used to modify the UE's default cell search and selection parameters to more quickly detect and connect to a particular air cell frequency.

### SUMMARY

The present disclosure is directed to improving cell search procedures of an airborne user equipment (UE), substantially as shown and/or described in connection with at least one of the Figures, and as set forth more completely in the claims.

According to various aspects of the technology, a UE performs a cell search of one or more frequency bands based on whether the UE is airborne or terrestrial. Cell search, selection, and reselection are some of the most intensely battery-consuming activities a UE can perform in a modern telecommunications network. Particularly in instances where a UE has travelled to areas where its home public land mobile network (PLMN) may not be available (e.g., up in the air), a UE may exhaust its initial cell search of home-carrier-defined bands and perform an all-band search. Performing an all-band cell search is a processor-intense procedure, consuming significant amounts of computer processing resources and, particularly on smaller form UEs, limited battery resources. Particularly while in the UE is airborne, even the all-band cell search is unlikely to result in selection and attachment, and the process may needlessly repeat unless the UE is in non-searching mode (e.g., airplane mode). By performing a targeted cell search for airborne UEs, the UE will realize significant power conservation by way of less processing resource utilization.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached Figures, which are intended to be exemplary and non-limiting, wherein:

FIG. 1 illustrates an exemplary computing device for use with the present disclosure;

FIGS. 2A and 2B. illustrate exemplary environments in which implementations of the present disclosure may be employed;

FIG. 3 depicts a flow diagram of an exemplary method for providing airborne wireless service, in accordance with embodiments described herein;

FIG. 4 depicts a flow diagram of an exemplary method for providing airborne wireless service, in accordance with embodiments described herein; and

FIG. 5 depicts a flow diagram of an exemplary method for providing airborne wireless service, in accordance with embodiments described herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022). As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, airborne UEs, whether drones or individual UEs on airplanes, often face difficulties in establishing reliable connections with terrestrial networks, particularly at higher altitudes. While telecommunication signals may be accessible at lower altitudes, typically below 10,000 feet during takeoff and landing, the limited time spent at these altitudes restricts service availability to critical phases of flight. Compounding this issue is the resource-intensive nature of cell searching, which is essential for a UE to identify suitable base stations for connection. Cell searching involves tuning to a frequency, monitoring for synchronization signals transmitted from a cell, decoding these signals, and determining the cell's suitability. This process consumes significant processing and power resources, with delays in cell search potentially leading to degraded performance and increased power consumption. Consequently, optimizing cell search algorithms and procedures is crucial for improving the reliability and efficiency of cellular connectivity for airborne UEs.

Conventionally, the methods used by airborne UEs to perform a cell search and attach to cell sites are the same regardless of whether the UE is terrestrial or airborne. Because of the resource-intensive nature of cell searching, which requires significant processing power and energy consumption, performing the same cell search in the air where a smaller subset of frequencies are available is an inefficient use of UE resources. Additionally, the need to scan multiple frequencies and decode synchronization signals increases the time and complexity of the attachment process, potentially leading to delays and degraded performance in establishing connections with cell sites. These challenges underscore the importance of developing more efficient and optimized cell search algorithms to improve the reliability and efficiency of cellular connectivity for airborne UEs.

Unlike conventional solutions, the present disclosure is directed to an “airborne mode” that can be on the UE. The UE can automatically turn on the airborne mode when it detects that the UE is airborne. For example, the UE may detect a particular altitude, speed, or pressure that is associated with being airborne. The airborne mode could be used to modify the UE's default cell search and selection parameters to more quickly detect and connect to a particular air cell frequency. For example, if a relatively small subset of frequencies were available to air cells (e.g., 600 MHZ, 800 MHZ, and/or 2.5 GHZ) and those particular frequencies were deprioritized for terrestrial cells, the airborne mode would only search for the particular airborne frequency to more quickly attach to a compatible cell site. This would improve the reliability and efficiency of cellular connectivity for airborne UEs. Then, once the UE detects that it is no longer airborne, it can go back to a terrestrial search mode to connect to a cell site that serves terrestrial UEs.

Accordingly, a first aspect of the present disclosure is directed to a method for performing a cell search for an airborne UE, the method comprises determining that the UE is airborne. The method also comprises modifying a cell search and selection procedure from a default procedure to an airborne procedure to prioritize a first set of frequencies over a second set of frequencies, wherein the second set of frequencies are prioritized when the UE is not airborne. The method also comprises connecting to a frequency of the first set of frequencies based on the results of the airborne procedure. The method also comprises reverting to the default procedure based on a determination that the UE is no longer airborne.

A second aspect of the present disclosure is directed to a method for modifying a handover procedure for an airborne UE. The method comprises determining that the UE is airborne and monitoring a signal strength of a serving cell and one or more neighboring cells associated with the UE. The method further comprises determining a modified hysteresis margin for a handover based the UE being airborne and based on the monitored signal strength of the serving cell and the one or more neighboring cells. The method further comprises adjusting a handover trigger threshold based on the modified hysteresis margin. The method also comprises initiating the handover of the UE from the serving cell to a neighboring cell of the one or more neighboring cells when the signal strength of the neighboring cell exceeds the handover trigger threshold by the modified hysteresis margin.

Another aspect of the present disclosure is directed to a method for modifying a handover procedure for an airborne UE. The method comprises determining that a UE is airborne and based on said determination, modifying a cell search and selection procedure from a default procedure to an airborne procedure to prioritize a first set of frequencies over a second set of frequencies, wherein the second set of frequencies are prioritized when the UE is not airborne. The method also comprises detecting a first cell and connecting to a first frequency of the first set of frequencies that are included in the airborne procedure for the first cell. The method also comprises detecting one or more neighboring cells based on the UE moving locations. The method also comprises monitoring a signal strength of the first cell and the one or more neighboring cells associated with the UE. The method also comprises determining a modified hysteresis margin for a handover based the UE being airborne and based on the monitored signal strength of the first cell and the one or more neighboring cells. The method also comprises adjusting a handover trigger threshold based on the modified hysteresis margin and initiating the handover of the UE from the first cell to a neighboring cell of the one or more neighboring cells when the signal strength of the neighboring cell exceeds the handover trigger threshold by the modified hysteresis margin.

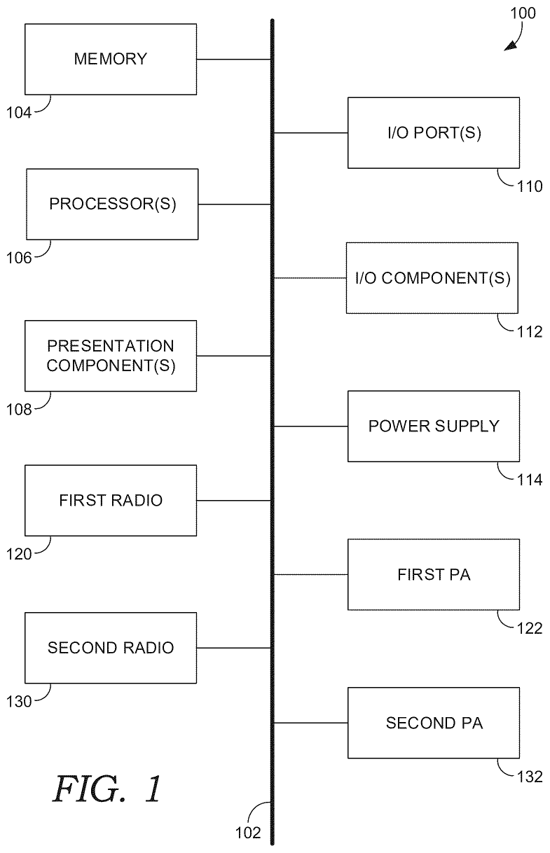

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment, wireless communication device, or user device, The computing device 100 may take many forms; non-limiting examples of the computing device 100 include a fixed wireless access device, cell phone, tablet, internet of things (IOT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

A first radio 120 and second radio 130 represent radios that facilitate communication with one or more wireless networks using one or more wireless links. In aspects, the first radio 120 utilizes a first transmitter 122 to communicate with a wireless network on a first wireless link and the second radio 130 utilizes the second transmitter 132 to communicate on a second wireless link. Though two radios are shown, it is expressly conceived that a computing device with a single radio (i.e., the first radio 120 or the second radio 130) could facilitate communication over one or more wireless links with one or more wireless networks via both the first transmitter 122 and the second transmitter 132. Illustrative wireless telecommunications technologies include CDMA, GPRS, TDMA, GSM, and the like. One or both of the first radio 120 and the second radio 130 may carry wireless communication functions or operations using any number of desirable wireless communication protocols, including 802.11 (Wi-Fi), WiMAX, LTE, 3G, 4G, LTE, 5G, NR, VoLTE, or other VOIP communications. In aspects, the first radio 120 and the second radio 130 may be configured to communicate using the same protocol but in other aspects they may be configured to communicate using different protocols. In some embodiments, including those that both radios or both wireless links are configured for communicating using the same protocol, the first radio 120 and the second radio 130 may be configured to communicate on distinct frequencies or frequency bands (e.g., as part of a carrier aggregation scheme). As can be appreciated, in various embodiments, each of the first radio 120 and the second radio 130 can be configured to support multiple technologies and/or multiple frequencies; for example, the first radio 120 may be configured to communicate with a base station according to a cellular communication protocol (e.g., 4G, 5G, 6G, or the like), and the second radio 130 may configured to communicate with one or more other computing devices according to a local area communication protocol (e.g., IEEE 802.11 series, Bluetooth, NFC, z-wave, or the like).

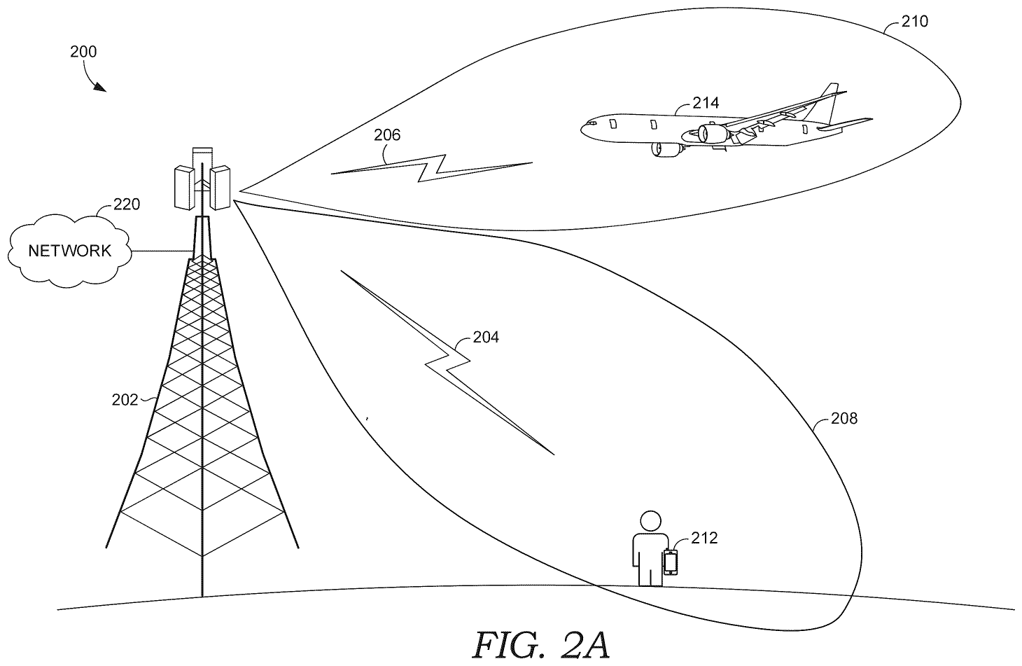

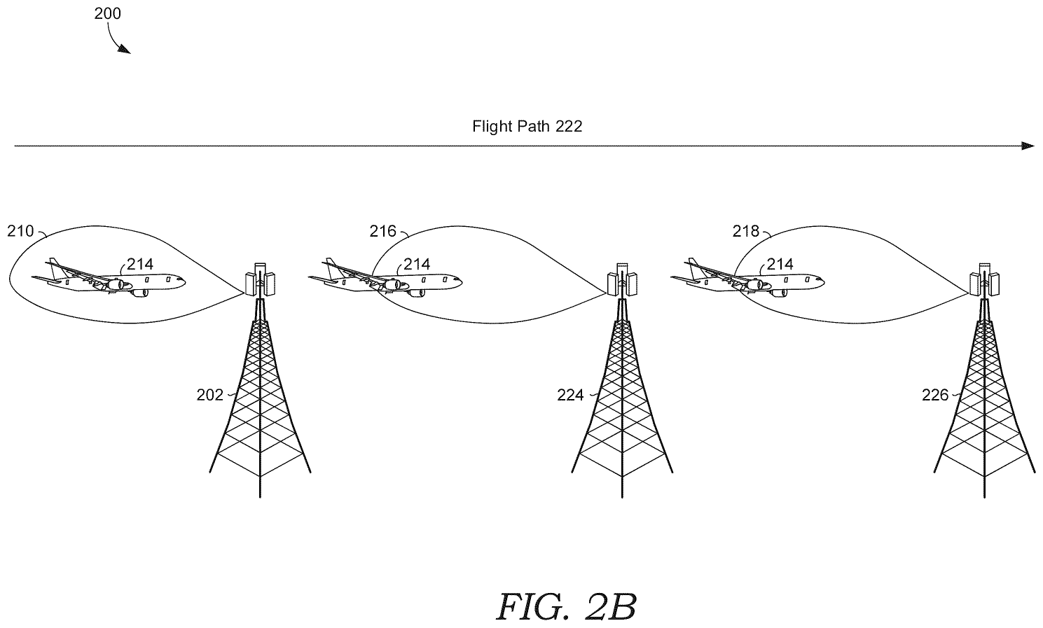

Turning now to FIGS. 2A and 2B, exemplary network environments are illustrated in which implementations of the present disclosure may be employed. Such a network environment is illustrated and designated generally as network environment 200. At a high level the network environment 200 comprises a base station 202, a telecommunication network 220, and one or more UEs. The base station 202 is configured to provide wireless telecommunication service to each of a first coverage area 208 and a second coverage area 210. As illustrated, the network environment comprises a terrestrial UE 212 located in the first coverage area 208 and connected to the base station 202 via a first wireless link 204, and an airborne UE 214 (depicted as a user flying in an airplane) located in the second coverage area 210 and connected to the base station 202 via a second wireless link 206. Though the terrestrial UE 212 is illustrated as a phone, a UE suitable for implementations with the present disclosure may be any computing device that is connected to a base station and is utilizing a terrestrial coverage area (e.g., first coverage area 208) having any one or more aspects described with respect to FIG. 1. Additionally, though the airborne UE 214 is illustrated as being associated with an airplane, a UE suitable for implementations with the present disclosure may be any computing device, such as a drone, smart/connected airplane, or the like, that is connected to a base station and is utilizing an airborne coverage area (e.g., second coverage area 210) having any one or more aspects described with respect to FIG. 1. Similarly, though the base station 202 is illustrated as a macro cell on a cell tower, any scale or form of access point acting as a transceiver station for wirelessly communicating with a UE, including small cells, pico cells, and the like, are suitable for use with the present disclosure.

The base station 202 uses one or more sets of unique frequencies to which both the terrestrial UE 212 and the airborne UE 214 may potentially connect to (also referred to as ‘camping on,’ ‘attaching’ in the industry). Though the network environment 200 is illustrated with one base station 202, one skilled in the art will appreciate that more base stations may be present in any particular network environment. The base station 202 of network environment 200 may operate the first wireless link 204 and the second wireless link 206 using one or more frequencies. The base station 202 may communicate with a UE using any wireless telecommunication protocol desired by a network operator, including but not limited to 3G, 4G, 5G, 6G, 802.11x and the like. Relevant to the present disclosure, each of the one or more base stations is associated with at least one network identifier (e.g., a PLMN number). In some implementations, the base station 202 is configured to communicate with one or more UEs located within a geographical area. The geographical area for any particular base station may be referred to as the “coverage area” of the base station or simply the “cell,” as used interchangeably herein. In some aspects, the coverage area for each particular base station is defined by an area in which signaling between a particular UE and the base station is usable for any purpose; in other aspects, the coverage area may be defined by mobile network operators. Generally, each base station may comprise one or more base transmitter stations, radios, antennas, antenna arrays, power amplifiers, transmitters/receivers, digital signal processors, control electronics, GPS equipment, and the like.

The base station 202 may be associated with one or more at least partially distinct networks, wherein each network is associated with one or more network identifiers. Each network may be a telecommunications network(s) (e.g., a packet data network or core network), data network, or portions thereof. A telecommunications network that at least partially comprises the network environment 200 may include additional devices or components (e.g., one or more base stations) not shown. Those devices or components may form network environments similar to what is shown in FIGS. 2A and 2B, and may also perform methods in accordance with the present disclosure. Components such as terminals, links, and nodes (as well as other components) may provide connectivity in various implementations. For the purposes of illustrating the present disclosure, the base station 202 may be connected to the network 220. The network 220 may include multiple networks, as well as being a network of networks, but is shown in more simple form so as to not obscure other aspects of the present disclosure.

The base station 202 is configured to transmit downlink signals to one or more UEs, such as the terrestrial UE 212 and airborne UE 214, and to receive uplink signals from them. These downlink signals typically include various sets of synchronization signals, such as primary synchronization signals (PSS), secondary synchronization signals (SSS), and physical broadcast channel (PBCH) signals, which provide essential information about the base station 202. Additionally, the downlink signals may contain various other control and broadcast signaling, including physical downlink shared channel (PDSCH) signaling. In practical terms, when a UE initiates communication, it scans a broad range of frequencies to identify available base stations. This scanning process involves tuning to a frequency and monitoring for synchronization signals, like the master information block (MIB), transmitted from nearby cells. Once these synchronization signals are detected and decoded, the UE assesses the suitability of each cell based on factors such as signal strength and quality. Subsequently, the UE listens for additional signals, such as system information block one (SIB1), to complete the attachment process.

In order to connect to any base station, a UE must perform an active search to determine which base stations, if any, it is capable of connecting to. This process is known to many in the art and referred to herein as a ‘cell search,’ and generally comprises acquiring time and frequency synchronization with a cell associated with a base station and detecting an identity of that cell by tuning to one or more specific frequencies, detecting/decoding synchronization signals, detecting/decoding the PBCH, and detecting/decoding the PDSCH. When performing the cell search, a particular UE actively scans frequency bands in which it is capable of communicating for synchronization signals from a base station. Upon detection of synchronization signals from one or more base stations, the UE will perform a cell selection procedure (typically based on best quality of service metrics or finding a cell with a network identifier that matches its own), perform an attachment procedure with the base station, and then begin carrying out a wireless communication session. As noted earlier, cell search and selection procedures are often quite taxing on a UE and, if performed constantly due to a lack of successful selection/attachment, can lead to rapid and undesirable depletion of a UE's battery. In many areas, power generation relied upon for supplying power used to recharge a UE is carbon-based; therefore, in many instances, avoidable power consumption equates to avoidable greenhouse gas emissions. In order to prevent the constant active searching for signals during cell search, and to reduce greenhouse gas emissions caused by power generation, the present disclosure is directed to a targeted cell searching paradigm specifically for airborne UEs that eliminates the need for a UE to blindly search all frequencies supported by a UE during cell search.

In aspects, the UE determines whether it is airborne as a basis for selecting between a terrestrial cell search procedure and an airborne cell search procedure. This determination can be automatically, based on changes in the UE such as the UE's altitude exceeding a predetermined threshold (e.g., 7,000 feet), the UE's speed exceeding a predetermined threshold (e.g., 100 mph), a change in the UE's pressure measurement that exceeds a predetermined threshold (e.g., decreasing at greater than 0.5 inches of mercury per minute), and/or a pressure measurement by the UE being below a predetermined threshold (e.g., less than 24 inches of mercury). In alternative aspects, the user can manually input into the UE that it is airborne. Once the UE 214 has been determined to be airborne, it will perform a targeted (e.g., modified) cell search and selection procedure.

In response to determining that a UE is airborne, the UE 214 can modify its cell search and selection procedure from a default (terrestrial) procedure to an airborne procedure. The bifurcated cell searching procedures may differ on the basis of different network identifiers (e.g., PLMNs) or different frequencies. In a first embodiment, if the first coverage area 208 is associated with a first PLMN and the second coverage area 210 is associated with a second PLMN, then the terrestrial cell search procedure may prioritize the first PLMN and disregard the second PLMN and the airborne cell search procedure may prioritize the second PLMN and de-prioritize (or ignore) the second PLMN. In a second embodiment, if a first set of frequencies are used for terrestrial cells such as the first coverage area 208 and a second set of different frequencies are used for airborne cells such as the second coverage area 210, then a particular UE will prioritize the relevant frequencies based on the outcome of determining whether it is airborne or not. In some aspects, the first set of frequencies and the second set of frequencies may be exclusive (no overlap), in other aspects, at least some frequencies may overlap between the terrestrial and airborne serving frequencies.

Once it is determined that a UE is no longer airborne (e.g., terrestrial), the cell search and selection procedure can revert back to the terrestrial cell search procedure and connect to the terrestrial frequency. That is, a UE may perform terrestrial cell search procedure in response to an affirmative determination that it is at or near the ground or in response to an absence of determining (i.e., a negative determination) that the UE is airborne.

Turning now to FIG. 2B, network environment 200 is depicted at three different points in time in which implementations of the present disclosure may be employed. As illustrated by FIG. 2B, the airborne UE 214 is following a known flight path 222. A known flight path for purposes of this disclosure is a predetermined route or trajectory that an aircraft follows during its journey from one location to another. At a first time, the airborne UE is within a first coverage area 210 served by base station 202. At a second point in time, the airborne UE moves along the known flight path 222 where it leaves the first coverage area 210 and enters a second coverage area 216 served by a second base station 224. As the airborne UE 214 continues to move along the known flight path 222, it leaves the second coverage area 216 at a third point in time and enters a third coverage area 218 served by a third base station 226, and so on and so forth. As the airborne UE 214 transitions between the different points in time, and thus the different coverage areas served by distinct base stations along the known flight path 222, the process involves handovers. Handovers are the mechanisms through which a mobile device, such as the airborne UE 214, seamlessly switches its connection from one cell to another as it moves. This transition ensures continuous network connectivity and optimal service quality for the UE throughout its journey. Hysteresis, in the context of handovers, refers to a technique used to prevent frequent and unnecessary handovers between adjacent cells. It introduces a buffer or threshold around the boundary of each coverage area, within which the UE remains associated with its current base station even if the signal strength from a neighboring base station becomes momentarily stronger. This prevents rapid oscillation or “ping-ponging” of the UE between neighboring cells, which can degrade performance and cause unnecessary signaling overhead in the network. Therefore, as the airborne UE 214 progresses along the known flight path 222 and crosses coverage area boundaries, hysteresis mechanisms in the network ensure that handovers occur only when necessary and advantageous for maintaining a stable and high-quality connection.

In aspects, at a first time, the UE 214 is determined to be airborne using the metrics mentioned above. Upon determining that the UE 214 is airborne, it can start monitoring a signal strength of the first cell 210 (i.e., its serving cell) in addition to one or more neighboring cells associated with the airborne UE 214, such as the second cell 216 and the third cell 218. In aspects, monitoring the signal strength can comprise periodically receiving signal strength indicators (RSSI) from the first cell 210 and the one or more neighboring cells 216, 218. Based on a few factors such as determining that the UE 214 is airborne and the monitored signal strength of the nearby cells (e.g., 210, 216, 218), the airborne UE 214 can modify its hysteresis margin for its handovers to adjust a handover trigger threshold. The hysteresis margin, in the context of handovers between coverage areas, refers to a parameter that determines when a handover occurs based on signal strength or other metrics. By adjusting this margin, the sensitivity of the handover process can be controlled. In the scenario of the known flight path 222, where the aircraft moves steadily along its route, it may be reasonable to increase the hysteresis margin to avoid unnecessary handovers. This adjustment ensures that the aircraft maintains its connection to the current coverage area until it approaches the coverage boundary of the next coverage area along the route. By doing so, the aircraft can avoid frequent handovers that could disrupt communication and consume additional resources. By analyzing factors such as signal strength, quality, and the aircraft's trajectory, the system can adjust the handover trigger threshold dynamically, and in some cases, based on real-time network conditions. In aspects, the handover trigger threshold is adjusted based on the metrics discussed above, such as the airborne UE's 214 mobility patterns and speed being above a predetermined threshold.

Once the handover trigger threshold has been adjusted, the airborne UE 214 can handover from the first cell 210 to a neighboring cell of the one or more neighboring cells 216, 218 when the signal strength or the neighboring cell exceeds the handover trigger threshold by the modified hysteresis margin. In aspects, determining the modified hysteresis margin comprises comparing the signal strength of the first cell 210 and the one or more neighboring cells 216, 218 over a predetermined time window. For example, based on the UE 214 being airborne and based on the determined modified hysteresis margin, the measurement reporting thresholds for the first cell 210 and the one or more neighboring cells 216, 218 can be adjusted. Furthermore, the adjusted measurement reporting thresholds can comprise increasing a reporting threshold for the cell 210 and decreasing a reporting threshold for the one or more neighboring cells 216, 218.

Moving along, as the airborne UE 214 transitions between different coverage areas served by distinct base stations along the known flight path 222, the system may modify the hysteresis margin to optimize handover decisions. This proactive approach reduces unnecessary cell search overhead and battery consumption while maintaining seamless connectivity throughout the flight. For example, when flying along a known flight path, such as flight path 222, the aircraft follows a predictable trajectory without significant deviations. In such cases, the need to reconnect to a previously visited base station is minimal because the path is straight and the aircraft is not expected to return to areas it has already traversed. Therefore, configuring the system to “forget” old base stations after handover can streamline the handover process and reduce unnecessary signaling overhead. In aspects, the handover decisions can be based on quality of service (QOS) requirements and network congestion levels. Overall, optimizing the hysteresis margin and handover procedure for known flight paths can improve the efficiency of communication systems on aircraft, ensuring continuous connectivity while minimizing unnecessary handovers and resource consumption

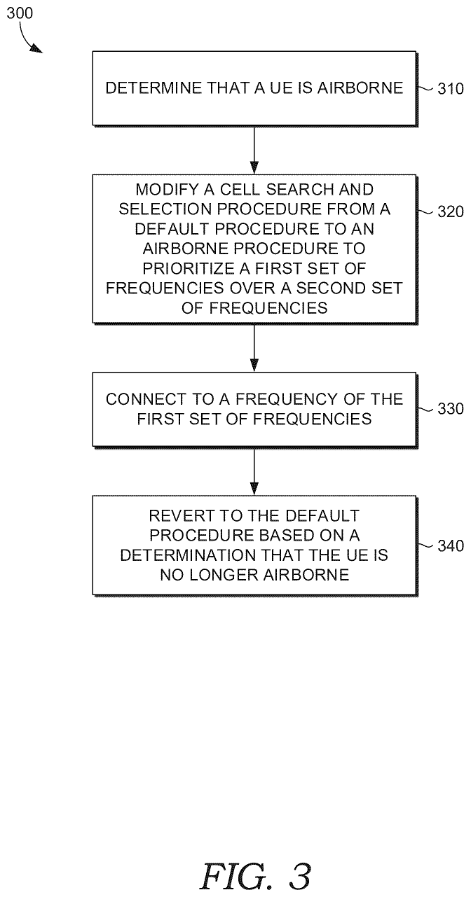

Turning now to FIG. 3, a flow chart representing a method 300 is provided. Generally the method 300 may be used by a UE, such as the terrestrial UE 212 or the airborne UE 214 of FIGS. 2A and 2B, to perform targeted cell search operations. At a first step 310, the UE is determined to be airborne. At a second step 320, the UE is modifying its cell search and selection procedure from a default procedure to an airborne procedure to prioritize a first set of frequencies over a second set of frequencies. At a third step 330, the UE is connecting to a frequency of the first set of frequencies based on the results of the airborne cell search and selection procedure. At step 340, the UE is reverting to the default procedure based on a determination that the UE is no longer airborne.

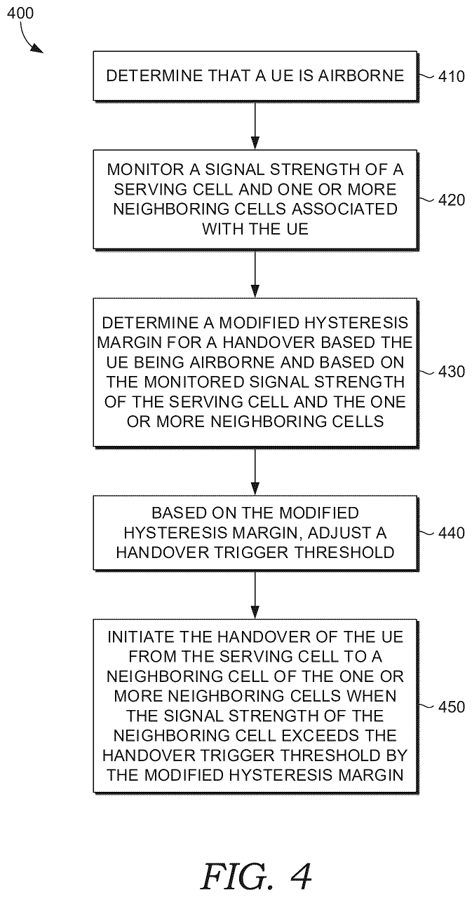

Turning now to FIG. 4, a flow chart representing a method 400 is provided. Generally the method 400 may be used by a UE, such as the terrestrial UE 212 or the airborne UE 214 of FIGS. 2A and 2B, to perform targeted cell search operations. At a first step 410, the UE is determined to be airborne. At a second step 420, the UE is monitoring a signal strength of a serving cell and one or more neighboring cells associated with the UE. At a third step 430, the UE is determining a modified hysteresis margin for a handover based the UE being airborne and based on the monitored signal strength of the serving cell and the one or more neighboring cells. At a fourth step 440, the UE is adjusting a handover trigger threshold based on the modified hysteresis margin. At step 450, the UE is initiating the handover of the UE from the serving cell to a neighboring cell of the one or more neighboring cells when the signal strength of the neighboring cell exceeds the handover trigger threshold by the modified hysteresis margin.

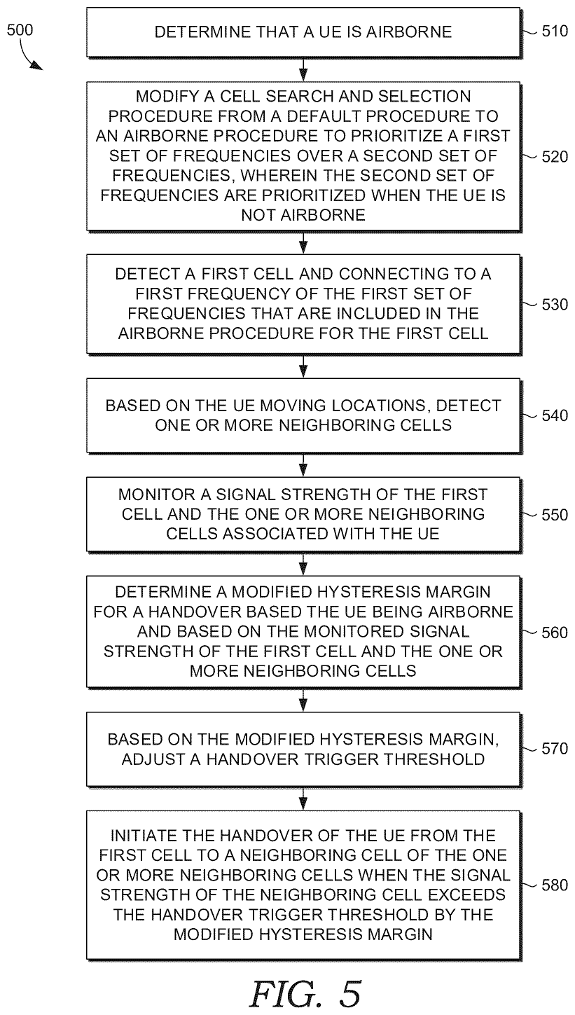

Turning now to FIG. 5, a flow chart representing a method 500 is provided. Generally the method 500 may be used by a UE, such as the terrestrial UE 212 or the airborne UE 214 of FIGS. 2A and 2B, to perform targeted cell search operations. At a first step 510, the UE is determined to be airborne. At a second step 520, the UE is modifying its cell search and selection procedure from a default procedure to an airborne procedure to prioritize a first set of frequencies over a second set of frequencies, wherein the second set of frequencies are prioritized when the UE is not airborne. At a third step 530, the UE is detecting a first cell and connecting to a first frequency of the first set of frequencies that are included in the airborne procedure for the first cell. At a fourth step 540, the UE is detecting one or more neighboring cells based on it moving locations. At step 550, the UE is monitoring a signal strength of the first cell and the one or more neighboring cells associated with the UE. At step 560, the UE is determining a modified hysteresis margin for a handover based the UE being airborne and based on the monitored signal strength of the first cell and the one or more neighboring cells. At a step 570, the UE is adjusting a handover trigger threshold based on the modified hysteresis margin. At step 580, the UE is initiating the handover of the UE from the serving cell to a neighboring cell of the one or more neighboring cells when the signal strength of the neighboring cell exceeds the handover trigger threshold by the modified hysteresis margin.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A method for performing a cell search for an airborne user equipment (UE), the method comprising:
determining that a UE is airborne; and
based on said determination, modifying a cell search and selection procedure from a default procedure to an airborne procedure to prioritize a first set of frequencies over a second set of frequencies,
wherein the second set of frequencies are prioritized when the UE is not airborne.

2. The method of claim 1, further comprising based on the results of the airborne procedure, connecting to a frequency of the first set of frequencies.

3. The method of claim 2, further comprising reverting to the default procedure based on a determination that the UE is no longer airborne.

4. The method of claim 3, wherein the determination that the UE is airborne is based on the UE's altitude exceeding a predetermined threshold.

5. The method of claim 3, wherein the determination that the UE is airborne is based on the UE's speed exceeding a predetermined threshold.

6. The method of claim 3, wherein the determination that the UE is airborne is based on a pressure measurement by the UE being below a predetermined threshold.

7. The method of claim 6, wherein the pressure measurement is a change in pressure that exceeds the predetermined threshold.

8. The method of claim 1, wherein a cell search priority list used during the airborne procedure is stored locally on the UE.

9. The method of claim 1, wherein determining that the UE is airborne is based on an input from a user.

10. A method for modifying a handover procedure for an airborne user equipment (UE), the method comprising:
determining that a UE is airborne;
monitoring a signal strength of a serving cell and one or more neighboring cells associated with the UE;
determining a modified hysteresis margin for a handover based the UE being airborne and based on the monitored signal strength of the serving cell and the one or more neighboring cells;
based on the modified hysteresis margin, adjusting a handover trigger threshold; and
initiating the handover of the UE from the serving cell to a neighboring cell of the one or more neighboring cells when the signal strength of the neighboring cell exceeds the handover trigger threshold by the modified hysteresis margin.

11. The method of claim 10, wherein upon the handover of the UE from the serving cell to the neighboring cell based on the handover trigger threshold and the modified hysteresis margin, preventing subsequent handovers back to the serving cell for a predetermined duration determined by a speed of the UE and a likelihood of it re-entering the serving cell's coverage area.

12. The method of claim 10, wherein monitoring the signal strength comprises periodically received signal strength indicators (RSSI) from the serving cell and the one or more neighboring cells.

13. The method of claim 10, wherein determining the modified hysteresis margin comprises comparing the signal strength of the serving cell and the one or more neighboring cells over a predetermined time window.

14. The method of claim 10, further comprising adjusting measurement reporting thresholds for the serving cell and the one or more neighboring cells based on the determined modified hysteresis margin and based on the UE being airborne.

15. The method of claim 14, wherein adjusting measurement reporting thresholds comprises increasing a reporting threshold for the serving cell and decreasing a reporting threshold for the one or more neighboring cells.

16. The method of claim 10, wherein the handover trigger threshold is adjusted dynamically based on real-time network conditions.

17. The method of claim 10, wherein the handover trigger threshold is adjusted based on user equipment (UE) mobility patterns and speed being above a predetermined threshold.

18. The method of claim 10, further comprising prioritizing handover decisions based on quality of service (QoS) requirements and network congestion levels.

19. A method for modifying a handover procedure for an airborne user equipment (UE), the method comprising:
determining that a UE is airborne;
based on said determination, modifying a cell search and selection procedure from a default procedure to an airborne procedure to prioritize a first set of frequencies over a second set of frequencies, wherein the second set of frequencies are prioritized when the UE is not airborne;
detecting a first cell and connecting to a first frequency of the first set of frequencies that are included in the airborne procedure for the first cell;
based on the UE moving locations, detecting one or more neighboring cells;
monitoring a signal strength of the first cell and the one or more neighboring cells associated with the UE;
determining a modified hysteresis margin for a handover based the UE being airborne and based on the monitored signal strength of the first cell and the one or more neighboring cells;
based on the modified hysteresis margin, adjusting a handover trigger threshold; and
initiating the handover of the UE from the first cell to a neighboring cell of the one or more neighboring cells when the signal strength of the neighboring cell exceeds the handover trigger threshold by the modified hysteresis margin.

20. The method of claim 19, further comprising reverting to the default procedure based on a determination that the UE is no longer airborne.
